(19) United States
(12) Patent Application Publication
(10) Pub. No.: US 2007/0253414 A1
(43) Pub. Date: Nov. 1, 2007

(54) Method for Preventing Data Packet Losses When Updating an Address Table

(75) Inventors: Hannes Meyer, Stephanskirchen-Schlossb (DE); Klaus-Peter Schwank, Martinsried (DE); Joachim Seifert, Kirchseeon (DE); Richard Vierthaler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/662,676

(22) PCT Filed: Sep. 28, 2005
(86) PCT No.: PCT/EP05/54877

§ 371 Date: Mar. 13, 2007

(30) Foreign Application Priority Data
Sep. 30, 2004 (EP) 04023271.2

(51) Int. Cl. H04L 29/12

(52) U.S. Cl. 370/389

(57) ABSTRACT

In one aspect, a method for preventing data packet losses when updating of an address table that is stored in a computer of a local area network and comprises allocations of computer addresses valid in the local area network to computer addresses valid in the Internet to mail data packets is provided. Accordingly, an address allocation stored in the address table is updated after an expiration of a timer. The computer requests the computer address valid in the local area network regarding the available computer address valid in the Internet for the address allocation. The determined computer address valid in the local area network is entered into the address allocation and the marking for the address allocation is cleared. Thus, an address allocation available is kept even when the address allocation is updated, resulting in preventing data packet losses and maintaining the quality of the local area network.

### CROSS REFERENCE TO RELATED APPLICATIONS

This application is the US National Stage of International Application No. PCT/EP2005/054877, filed Sep. 28, 2005 and claims the benefit thereof. The International Application claims the benefits of European application No. 04023271.2 EP filed Sep. 30, 2004, both of the applications are incorporated by reference herein in their entirety.

### FIELD OF INVENTION

The invention relates to a method for preventing packet losses during the updating of an address table that is stored in a computer of a local area network and contains assignments of computer addresses that are valid in said local area network to computer addresses that are valid in the internet for the purpose of dispatching data packets, with an address assignment stored in the address table being updated after a validity timer has timed out.

### BACKGROUND OF INVENTION

The term “internet” is generally understood as referring to a large, global, but decentralized computer network consisting of numerous subnetworks. Such subnetworks can for example be local area networks which are geographically limited. Said local area networks are also referred to as LANs for short and can for example be computer networks of individual organizations or institutions.

The so-called Internet Protocol, or IP for short, is used for data transfer in the internet or, as the case may be, from or to the individual subnetworks of the internet. The IP is responsible for the connectionless transport of data in packet form—referred to as IP data packets—from a computer in a subnetwork to a target computer in a subnetwork via a plurality of subnetworks. In order that an IP data packet can be routed to a specific computer in a subnetwork, addressing of the computers of the subnetworks is carried out in the IP. When being configured, each computer is assigned a computer address, the so-called IP address, that is valid in the internet. Said addressing is performed on Layer 3 of the OSI reference model.

The IP address enables a computer in the internet or, as the case may be, in the subnetwork to which it is assigned, to be uniquely addressed. This means that a data packet is transmitted from a sending computer to a target computer on the basis of this address that is valid in the internet, with the two computers residing in different subnetworks. The data packets are forwarded between the subnetworks on the basis of the IP address.

Within a subnetwork, particularly when the latter is implemented as a LAN, the addressing of the individual computers in the local area network is additionally carried out on Layer 2 of the OSI reference model. In a LAN, therefore, a distinction is made in accordance with the different layers of the OSI reference model between a hardware address, called the Media Access Control or MAC address, and the IP address valid in the internet. Each computer in a local area network therefore has at least one MAC and one IP address via which it can be addressed and which are known to the computer. The MAC address, which is unique worldwide if the LAN is based on what is referred to as Ethernet technology, is used for the transmission of data packets within a local area network from a sending computer to a target computer.

In Ethernet technology, the data is transported over a common transmission channel. Said transmission channel is accessed according to the collision method. This means that each computer that has data to send accesses the common transmission channel if the latter has been detected as free by the sending computer. By means of the collision method the concurrent accessing of the transmission channel by two computers is detected and indicated. The send operation is repeated by the computers after a predefined period of time. With Ethernet technology, the data is transmitted in what are referred to as datagrams or frames whose length is flexible and in which the address of the target computer and the address of the sending computer within the local area network—in other words the MAC addresses of the computers—are entered in the frame format.

If a data packet in which the address of the target computer is also packed as an IP address is now to be routed to the target computer in a subnetwork implemented as a LAN, a computer address valid in the local area network for the target computer must be assigned to the IP address of the target computer in order for the data packet to be transmitted. In a LAN based on Ethernet technology, for example, the data packet is packed into a frame for the transmission and the MAC address of the target computer is entered in this frame. The data packet is sent to the target computer with the aid of this address that is valid in the local area network.

The address associated with the IP address of the target computer and valid in the local area network is requested by the computer forwarding the data packet by way of a protocol such as, for example, the Address Resolution Protocol. The Address Resolution Protocol, or also called ARP for short, has the task of establishing the format in which computer addresses are available and where applicable to convert said addresses from one format to the other format.

### SUMMARY OF INVENTION

In order to avoid the need to determine the associated computer address that is valid in the local area network for every data packet that is sent to a specific target computer in a local area network, the assignments of computer address valid in the internet and computer address valid in the local area network are stored in an address table. The address assignments in said address table are mostly provided with a timer by means of which their validity is restricted. This means that the address assignments are deleted from the address table after a specific period time determined by the expiration of the validity timer. If a further data packet is subsequently to be sent to a target computer whose address assignment has been deleted from the address table, the assignment between the address of the target computer that is valid in the internet and the address that is valid in the local area network must be re-determined and stored in the address table once more.

In this scenario the problem arises that no data packets can be sent to this target computer during the new determination of the address assignment. A transmission of data packets cannot be initiated until after the address assignment has been entered in the address table.

In the solution approaches known from the prior art, data packets that are to be sent to a target computer during the determination and storing of the address assignment for this target computer are temporarily stored in a buffer. However, if said buffer is filled to capacity with data packets and therefore no further data packets can be accommodated by the buffer, data packets will be lost. The quality of the local area network, also referred to as Quality of Service, can then likewise no longer be maintained. The occurrence of this packet loss is dependent on several factors, such as, for example, the density of the data traffic to the affected target computer at the moment the address assignment becomes invalid, and consequently is difficult to calculate.

An object underlying the invention is therefore to specify a method which prevents this type of packet losses during the determination and storing of the address assignment for a target computer in the address table and maintains the quality of service of the local area network.

This object is achieved according to the invention by a method for preventing data packet losses during the updating of an address table that is stored in a computer of a local area network and contains assignments of computer addresses that are valid in the local area network to computer addresses that are valid in the internet for the purpose of dispatching data packets, with an address assignment stored in the address table being updated after a validity timer has timed out, with the address assignment being marked in the address table after the validity timer of an address assignment has expired, the computer address applicable in the local area network and associated with the present computer address that is valid in the internet being requested for this address assignment by the computer, the determined computer address applicable in the local area network being entered in thus address assignment in the address table and the marker for the address assignment being reset.

The method according to the invention has the advantage that an address assignment for a target computer is available even during the updating of the address assignment, thereby preventing losses of data packets and maintaining the quality of service of the local area network.

It is advantageous if the marked address assignment can continue to be used for sending data packets to the computer address applicable in the local area network and entered in this address assignment. In this way the queue of data packets in the buffer is reduced. The buffer is thus not filled to capacity with data packets. Consequently no data packets are lost due to a full buffer.

It is favorable in this case if the marker of the address assignment in the address table is assigned the meaning “assignment expired”. In this way it is known in the local area network that this address assignment is in the process of being updated.

It is also advantageous here if, after the validity timer has expired, the marked address assignment is deleted from the address table when this address assignment is not being requested for sending data packets. This prevents outdated address assignments that are no longer required for transmitting data packets from being retained in the address table.

It is also favorable if Ethernet technology is used for implementing the local area network. This is in particular because Ethernet technology is widely established in local area networks. In the year 2000 the proportion of local area networks based on Ethernet technology was estimated at 80%.

It is also advantageous if the Address Resolution Protocol is used for determining the address assignment of the computer address applicable in the local area network and associated with a computer address that is valid in the local area network. This is in particular because the Address Resolution Protocol converts computer addresses between different addressing protocols in a simple manner.

### BRIEF DESCRIPTION OF THE DRAWINGS

The invention is explained in more detail with reference to a sole figure. This shows by way of example the functional layout of a local area network in which the method according to the invention is used.

### DETAILED DESCRIPTION OF INVENTION

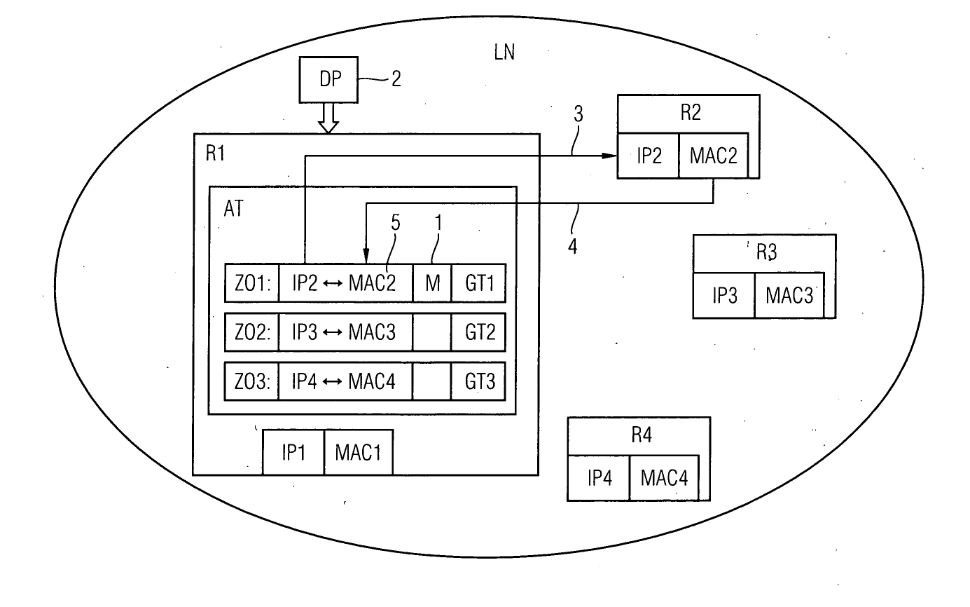

FIG. 1 shows a computer R1 in a local area network LN which also includes further computers R2, R3, R4. The internet-valid address IP1, IP2, IP3, IP4 and the addresses MAC1, MAC2, MACS, MAC4 of the respective computer R1, R2, R3, R4 that are valid in the local area network LN are stored on each computer R1, R2, R3, R4.

Additionally stored on the computer R1 is an address table AT in which address assignments ZO1 to ZO3 for the transmission of data packets DP to a computer R2, R3, R4 of the local area network LN are stored. By means of the address assignment ZO1, for example, the internet-valid address IP2 of the computer R2 is linked with the address MAC2 of this computer R2 that is valid in the local area network LN. If a data packet DP is now to be sent from the computer R1 to the computer R2, the address table AT is searched for the corresponding address assignment Z01 with the aid of the internet-valid address IP2 of the computer R2. The address MAC2 of the computer R2 that is valid in the local area network LN is determined by means of the address assignment Z01 in order to send the data packet DP to the computer R2.

The address table AT contains a validity timer GT1 to GT3 associated with each address assignment Z01 to Z03. If the validity timer GT1 has expired for the address assignment Z01, the address assignment Z01 is identified by a marker M in a step 1. The marker M indicates that the address assignment Z01 actually has the status “assignment expired”.

If, in a step 2, a data packet DP corresponding to the address assignment Z01 is now sent with the status “assignment expired”, the current address MAC2 of the target computer R2 that is valid in the local area network LN is requested in a step 3 by the sending computer R1 using the Address Resolution Protocol. In a step 4, the computer R2 thereupon transmits its address MAC2 that is valid in the local area network LN to the computer R1. In a step 5, the determined address MAC2 of the computer R2 that is valid in the local area network LN is entered in the address assignment Z01 in the address table AT and is thus linked with the internet-valid address IP2 of the computer R2. The marker M in the address assignment Z01 is thereupon reset.

In the event that no data packets DP are to be transmitted in the local area network LN within a specific period of time following the expiration of the validity timer GT1 with the aid of the address assignment Z01, the address assignment Z01 provided with the marker M is deleted from the address table AT.

1.-6. (canceled)

7. A method for preventing data packet losses during the updating of an address table stored in a computer of a local area network, comprising:
providing an address assignment including an association of a computer address that is valid in the local area network to a computer address that is valid in the internet for a sending of a data packet; and
marking the address assignment after an expiration of a validity timer for the address assignment;
wherein the computer address that is valid in the local area network and associated with the computer address that is valid in the internet is requested for the address assignment by the computer, and
wherein the determined computer address that is valid in the local area network is entered in the address assignment in the address table and the marker for the address assignment is reset.

8. The method as claimed in claim 7, wherein the marker of the marked address assignment indicates an expired assignment.

9. The method as claimed in claim 7, wherein the marked address assignment is deleted from the address table when the address assignment is not requested for the purpose of sending data packets after a time following the expiration of the validity timer.

10. The method as claimed in claim 7, wherein the marked address assignment continues to be used for sending data packets to the computer address that is valid in the local area network.

11. The method as claimed in claim 10, wherein the marker of the marked address assignment indicates an expired assignment.

12. The method as claimed in claim 10, wherein the marked address assignment is deleted from the address table when the address assignment is not requested for the purpose of sending data packets after a time following the expiration of the validity timer.

13. The method as claimed in claim 7, wherein an ethernet technology is used for implementing the local area network.

14. The method as claimed in claim 7, wherein an address resolution protocol is used for determining the address assignment of the computer address that is valid in the local area network for the computer address that is valid in the internet.

15. A method for preventing data packet losses during the updating of an address table stored in a computer of a local area network, comprising:
providing an address assignment including a relation of a computer address that is valid in the local area network to a computer address that is valid in the internet for the sending of data packets;
marking the address assignment to indicate an expired assignment in response to an expiration of a validity timer for the address assignment;
receiving a data packet corresponding to the marked address assignment;
in response to receiving the data packet corresponding to the marked address assignment:
sending the data packets to the computer address that is valid in the local area network;
updating the relation with the computer address that is valid in the local area network; and
resetting the mark in the marked address assignment,
wherein an address resolution protocol is used for determining the address assignment of the computer address that is valid in the local area network for the computer address that is valid in the internet.
